(19) United States
(12) Patent Application Publication
(10) Pub. No.: US 2017/0295981 A1
(43) Pub. Date: Oct. 19, 2017

(54) SUPPORT STRUCTURE FOR SUPPORTING A DECORATIVE ITEM

(71) Applicant: Shining Sea Trading Company, West Valley City, UT (US)

(72) Inventor: Jared Hendricks, Draper, UT (US)

(73) Assignee: Shining Sea Trading Company, West Valley City, UT (US)

(21) Appl. No.: 15/468,099

(22) Filed: Mar. 23, 2017

Related U.S. Application Data
(60) Provisional application No. 62/312,288, filed on Mar. 23, 2016.

(51) Int. Cl. A47G 33/10; F16M 13/02; F16C 11/06

(52) U.S. Cl. CPC A47G 33/10; F16C 11/06; F16M 13/022

(57) ABSTRACT

A device for supporting a decorative item on a top of a decorative support, such as a holiday tree, is disclosed and discussed. A support device can include a spiral body shaped to be securable to a top of a tree, wherein the spiral body extends from an upward end downward from the top of the tree, and a support body coupled to the upward end of the spiral body and extending in a direction opposite the downward spiral, wherein the support body is positioned support a decorative item when attached to a tree.

### PRIORITY DATA

This application claims the benefit of U.S. Provisional Patent Application Ser. No. 62/312,288, filed Mar. 23, 2016, which is incorporated herein by reference.

### BACKGROUND

There are many common customs that involve hanging decorative items on decorative structures such as trees, bushes, poles, posts, and the like. Decorative items can vary depending on the preferences of a user, a holiday or holiday season, and the like. It is often tradition to place a decorative item on the top of a real or artificial tree, such as a holiday tree, or a Christmas tree.

### BRIEF DESCRIPTION OF THE DRAWINGS

FIG. 1A illustrates a side view of a decorative item support in accordance with an example embodiment;

FIG. 1B illustrates a top down view of a decorative item support in accordance with an example embodiment;

FIG. 2A illustrates a side view of a decorative item support in accordance with an example embodiment;

FIG. 2B illustrates a side view of a portion of a decorative item support in accordance with an example embodiment;

FIG. 3 illustrates a side view of a decorative item support in accordance with an example embodiment;

FIG. 4A illustrates a side view of a portion of a decorative item support in accordance with an example embodiment;

FIG. 4B illustrates a side view of a portion of a decorative item support in accordance with an example embodiment;

FIG. 5 illustrates a side view of a portion of a decorative item support in accordance with an example embodiment;

FIG. 6A illustrates a side view of a portion of a decorative item support in accordance with an example embodiment;

FIG. 6B illustrates an isometric view of a portion of a decorative item support in accordance with an example embodiment; and

FIG. 6C illustrates a side view of a portion of a decorative item support in accordance with an example embodiment.

### DESCRIPTION OF EMBODIMENTS

Although the following detailed description contains many specifics for the purpose of illustration, a person of ordinary skill in the art will appreciate that many variations and alterations to the following details can be made and are considered included herein. Accordingly, the following embodiments are set forth without any loss of generality to, and without imposing limitations upon, any claims set forth. It is also to be understood that the terminology used herein is for describing particular embodiments only, and is not intended to be limiting. Unless defined otherwise, all technical and scientific terms used herein have the same meaning as commonly understood by one of ordinary skill in the art to which this disclosure belongs. Also, the same reference numerals in appearing in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various embodiments. One skilled in the relevant art will recognize, however, that such detailed embodiments do not limit the overall concepts articulated herein, but are merely representative thereof. One skilled in the relevant art will also recognize that the technology can be practiced without one or more of the specific details, or with other methods, components, layouts, etc. In other instances, well-known structures, materials, or operations may not be shown or described in detail to avoid obscuring aspects of the disclosure.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of phrases including “an example” or “an embodiment” in various places throughout this specification are not necessarily all referring to the same example or embodiment.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

There are many common customs that involve hanging decorative items on decorative structures such as trees, bushes, poles, posts, and the like. Decorative items can vary depending on the preferences of a user, a holiday or holiday season, and the like. It is often tradition to place a decorative item on the top of a real or artificial tree, such as a holiday tree, or a Christmas tree. It can sometimes be challenging, however, to place such decorative items, or “tree toppers,” both in terms of stability during the positioning process and stability over time. The decorative item generally includes a hollow bottom portion that is designed to fit over the an upper portion of the tree or structure on which it is being displayed. In many cases, particularly for trees, stability problems can arise. Holiday trees, for example, are usually shaped as an inverted cone, with an upward extending portion at the top. Due to the nature of tree growth, particularly for evergreen-type trees, the trunk of the tree is thicker at the bottom, and generally tapers to its thinnest point near the top of the tree. This portion of the tree, including the “evergreen” upwardly extending portion, is the least stable part of the tree. In many cases, this upwardly extending portion may need to be cut away to improve the stability of the decorative item resting there on, which can decrease the aesthetics of the tree. Furthermore, in addition to the stability related to the tree being capable of supporting the decorative item, positional stability of the decorative item may be problematic. Positional stability can include, for example, situations where the tree is relatively stable, but he hollow portion in the bottom of the decorative item has a shape that allows the decorative item to shift in position when positioned on the tree.

The present disclosure overcomes these issues, and provides a device for stably positioning a decorative item on the top of a natural or artificial decorative structure, where the decorative item is maintained in a stable position that does not require frequent readjustment. Furthermore, in some examples, the “topper” device can be fixed to the top of a decorative structure, and can be repositioned to approximate a vertical orientation. In one example, an adjustable topper is disclosed herein for use with decorative or other ornamental objects.

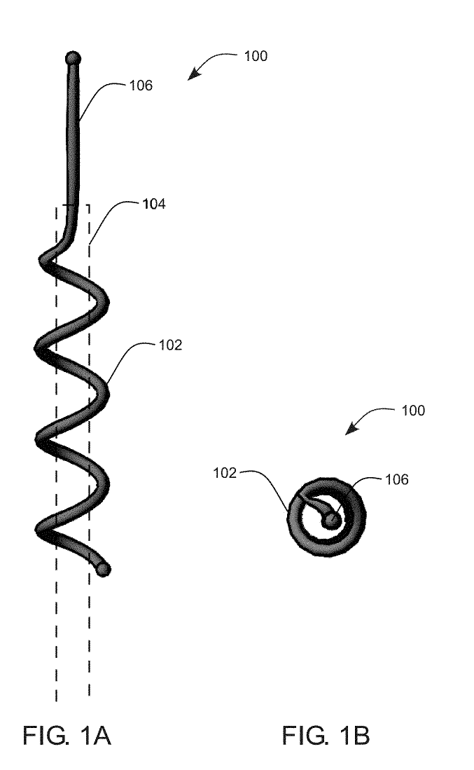

FIG. 1A shows one example of a topper 100 comprising a spiral body 102 shaped to spiral around a top region of a decorative support 104, such as a natural or artificial tree body, branch, or trunk, and the like. The topper 100 additionally includes a support body 106 extending from the spiral body 102 for supporting a decorative item during use. The shape of the spiral body 102 provides stiffening support to the upper portion of the decorative support 104, and distributes force applied by the decorative item along a portion of the length of the decorative support 104 to reduce lateral bending. In some examples, the topper 100 can be adjustable in order to vary the orientation of the support body 106 relative to the spiral body 102. For example, at least a portion of the support body 104, the spiral body 102, or both, can be made of a flexible material that deforms plastically. The spiral body 102 can be shaped to fit different sizes or configurations of decorative supports, adjusted lengthwise to accommodate heavier loads applied to the support body 104, and the like. Similarly, the length, thickness, and other physical characteristics of the support body 104 can be adjusted to accommodate variations across design supports, decorative items, and the like, including variations such as size, shape, weight, physical dimensions, etc. FIG. 1B shows a top down view of the topper 100 with the support body 106 and the spiral body 102 spiraling downward therefrom.

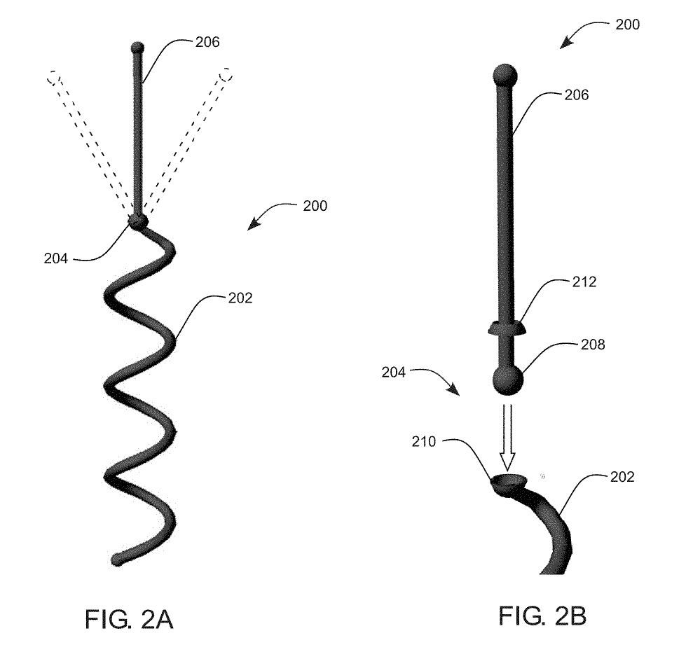

FIG. 2A shows another example of a topper 200 comprising a spiral body 202 shaped to spiral around a top region of a decorative support (not shown), such as a natural or artificial tree body, branch, or trunk, and the like. The topper 100 additionally includes a support body 206 extending from the spiral body 202 for supporting a decorative item during use. The support body 206 and the spiral body 202 are adjustably coupled together, in this case by a ball joint 204, which allows the orientation of the support body 206 to be varied relative to the spiral body 202. FIG. 2B shows an example of an opened ball joint 204, which can include a ball 208 coupled to the support body 206 and a ball cup 210 coupled to the spiral body 202. The ball joint 204 is assembled by resting the ball 208 in the ball cup 210 and coupling a ball joint cover 212 to the ball cup 210. This configuration allows the ball 208 to turn relative to the ball cup 210, thus facilitating the adjustment in orientation of the support body 206. The ball joint 204 (or any other type of adjustable coupling) can include a locking mechanism to adjustably secure the support body at a desired orientation. The locking mechanism can be a set screw, a locking pin, a clamp, or any other securing means. For a ball joint as shown in FIG. 2B, for example, a locking mechanism can be a set screw or any other locking mechanism capable of limiting the movement of the ball within the ball socket. In another example of a ball joint, a cover or other portion of the coupling can be configured to stop and release the ball movement between free and fixed states. A cover can also provide protection to the adjustable coupling to minimize the entry of debris. The adjustable coupling thus allows for the orientation of the support body to be adjusted, which can be performed before, during, or after placing the topper on the decorative support. Non-limiting examples can include hinges, hinge joints, pivot joints, ball joints, ball and socket joints, flexible extension rods, and the like, including a combination thereof. In one example.

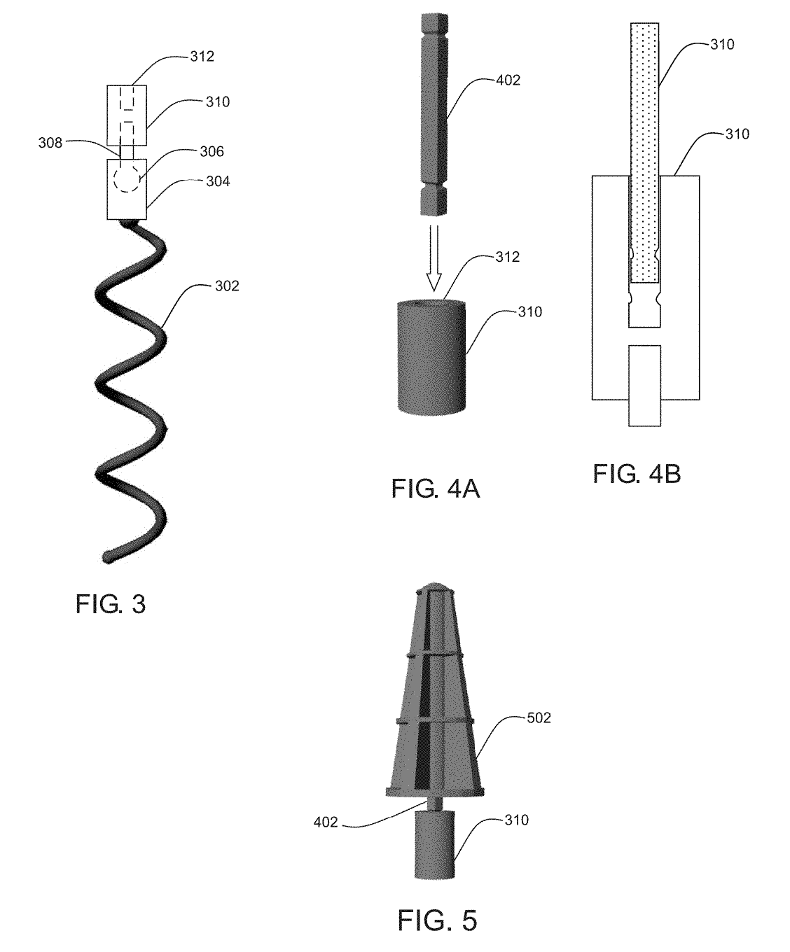

The support body, or a portion of the support body, can be detachable from the spiral body. In some cases, the support body can be, or can include a portion that is, interchangeable. In one example, as shown in FIG. 3, a spiral body 302 can be coupled to a ball socket block 304 into which a ball 306 is inserted to form a ball and socket joint, where the ball 306 includes a linear extension 308 for attaching to an extension socket block 310. The extension socket block 310 includes a second extension socket 312 in addition to the first socket coupled to the linear extension 308. As is shown in FIG. 4A, for example, the extension socket block 310 includes a second extension socket 312 into which a matching support extension 402 is inserted. FIG. 4B shows a view of the support extension 402 partially inserted into the second extension socket 312 of the extension socket block 310. Also shown is the linear extension 308 from the ball 306 inserted into the extension socket block 310. The support extension 402 can be a further extension, an attachment portion of a decorative item, an attachment portion configured to attach to a decorative item, and the like. FIG. 5, for example, illustrates an embodiment having an extension socket block 310 having a support extension 402 coupled thereto, where the support extension 402 is coupled to a decorative item support 502. The decorative item support 502 can be configured to support a decorative item securely and stably.

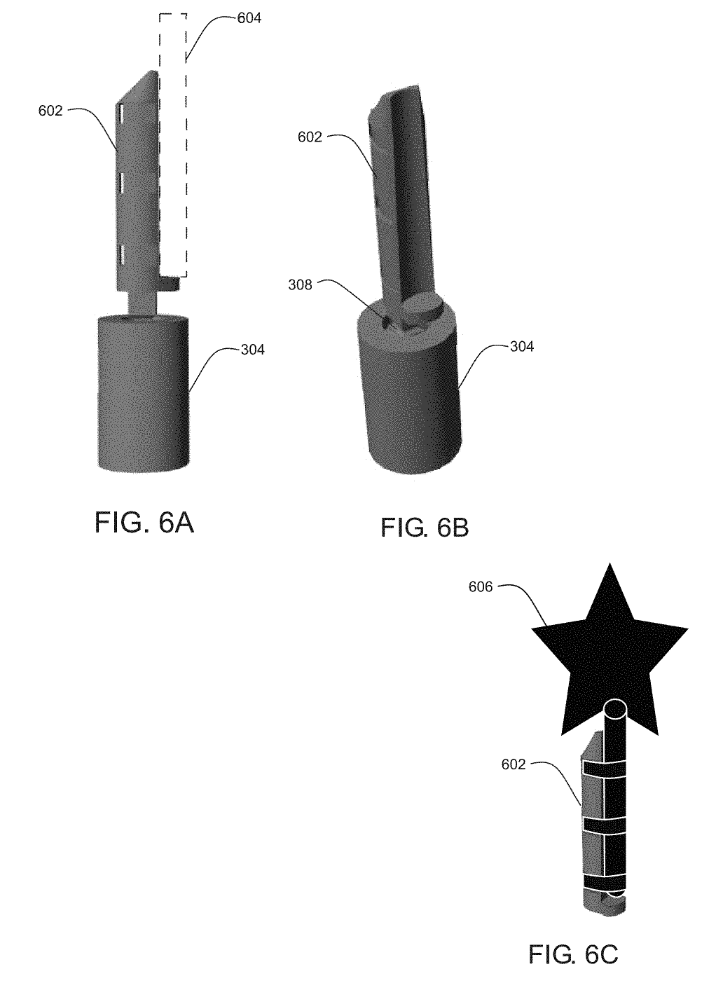

In another example, as shown in FIGS. 6A,B, a decorative item support 602 can be attached directly to the linear extension 308 of the ball 306. The decorative item support 602 can attach to a decorative item 604 by a variety of techniques, which is not considered to be limiting. In some cases, the decorative item support 502 shown in FIG. 5 can be coupled directly to the linear extension 308, and thus can support the decorative item in the same manner. FIG. 6C shows another example whereby a decorative item 606 can be coupled to the decorative item support 602.

The various structures described herein can include a variety of materials and/or material combinations, and such materials can be rigid, semirigid, flexible, etc. Nonlimiting examples of such materials can include metals, polymers, ceramics, wood materials, natural rubbers, and the like, including alloys, mixtures, and composites thereof. Non-limiting examples of metals include iron, nickel, copper, chromium, silver, platinum, gold, aluminum, tin, titanium, tungsten, tungsten carbide, steel, stainless steel, carbon steel, and the like, including alloys and combinations thereof (e.g. brass, bronze, etc.). Non-limiting examples of polymers include polyvinyl chloride, polyvinylidene chloride, polyethylene terephthalate, polyethylene, polypropylene, polystyrene, acrylonitrile butadiene styrene, polycarbonate, polyurethane, polyetheretherketone, polyimide, polymethyl methacrylate, silicon, polymer clay, copolymers, and the like, including combinations thereof. Non-limiting examples of ceramics can comprise aluminum oxides, magnesium oxide, zinc oxide, cobalt II oxides, and the like, including combinations thereof. In some embodiments, the structure comprises a combination of at least two of metal, a polymer, a ceramic, or a wood product. In some embodiments, all of the structures are composed of the same materials. In other embodiments, the individual components can be comprised of different materials with respect to one another.

As has been described, the length of the support and spiral bodies can vary depending on a variety of factors, such as the size and shape of the decorative structure, the size, shape, and weight of the decorative item, the design of the device, and the like. In some nonlimiting examples, however, the support and spiral bodies can each have a length of from 5 inches to 24 inches or more. In other nonlimiting examples, the support and spiral bodies can each have a length of from 12 inches to 36 inches or more. In yet other nonlimiting examples, the support and spiral bodies can each have a length of from 8 inches to 16 inches or more.

Further presented herein, is a method of using a topper to support a decorative item on a holiday tree. The method can comprise screwing the spiral body from the top of a tree part way down the tree center, attaching a decorative item to the support body, and orienting the support body into a desired position. In another example, a method of using a topper to support a decorative item on a holiday tree can include screwing the spiral body from the top of a tree part way down the tree center, orienting the support body into a desired position, and attaching a decorative item to the support body.

1. A support device, comprising:
a spiral body shaped to be securable to a top of a tree, wherein the spiral body extends from an upward end downward from the top of the tree;
a support body coupled to the upward end of the spiral body and extending in a direction opposite the downward spiral, wherein the support body is positioned support a decorative item when attached to a tree.

2. The device of claim 1, wherein the support body and the spiral body are coupled together by a coupling mechanism.

3. The device of claim 1, wherein the coupling mechanism is a ball joint.

4. The device of claim 1, wherein the coupling mechanism is a ball and socket joint.

5. The device of claim 4, wherein the ball and socket joint further comprises:
a coupling adjustment block coupled to the upward end of the spiral body, and further comprising a socket facing away from the spiral body; and
a ball rotationally positioned within the socket, the ball having a linear extension facing away from the spiral body.

6. The device of claim 5, wherein the linear extension is the support body.

7. The device of claim 5, further comprising socket block having a first socket and an opposing second socket, wherein the first socket is shaped to conformally couple to the linear extension, and the second socket is shaped to configure to a decorative item or a decorative item support.
